(19) United States
(12) Patent Application Publication
(10) Pub. No.: US 2010/0302630 A1
(43) Pub. Date: Dec. 2, 2010

(54) INCIDENT ILLUMINATION DEVICE FOR A MICROSCOPE

(75) Inventor: Robert Paulus, Hergatz (DE)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(73) Assignee: LEICA MICROSYSTEMS (SCHWEIZ) AG, Heerbrugg (CH)

(21) Appl. No.: 12/790,230

(22) Filed: May 28, 2010

(30) Foreign Application Priority Data
May 28, 2009 (DE) 102009026555.4

(51) Int. Cl. G02B 21/06

(52) U.S. Cl. 359/385

(57) ABSTRACT

An incident illumination device for a microscope for providing oblique or straight incident illumination is described. The illumination device comprises a light source that includes at least two 2-dimensional, surface light-emitting segments and is imaged into an aperture plane of the incident illumination device. At least one of the at least two light-emitting segments of the light source is designed to be activated individually. Further, a microscope comprising this incident illumination device is described, and methods of using this microscope both for oblique and straight illumination are described. In addition to conventional incident bright-field illumination, the described microscope and methods of use thereof allow also to select between angular or oblique incident illumination.

### CROSS-REFERENCE TO RELATED APPLICATION

This application claims the priority of the German patent application DE 102009026555.4 having a filing date of May 28, 2009. The entire content of this prior German patent application DE 102009026555.4 is herewith incorporated by reference.

### BACKGROUND OF THE INVENTION

The present invention relates to an incident illumination device for a microscope, a microscope equipped with such an incident illumination device, and incident illumination methods that can be implemented therewith.

Modern microscopes are increasingly using LEDs as light sources, because LEDs have various advantages over conventional incandescent or high-pressure lamps. LEDs usually have a longer life, are rugged, small in size, and generate significantly less heat.

A transmitted illumination device having a plurality of LEDs is described, for example, in WO 2006/136406 A1. However, the approach disclosed therein has the disadvantage that each LED of the plurality of LEDs must be provided with a lens to magnify and overlap the images of the source surfaces of the individual light sources in a manner so as to obtain homogenous white-light illumination. This involves considerable design complexity.

Japanese Patent Application JP 4125609 A describes a transmitted illumination device for a microscope, in which a number of LEDs are arranged in the front focal plane of the condenser. The illumination mode can be set by controlling the LEDs in different modes, allowing selection of bright-field, dark-field and oblique illumination. In order to sufficiently fill the aperture of the condenser, it is necessary to provide a multiplicity of LEDs. This, in combination with the variable control, requires a considerable contacting and wiring effort.

Other transmitted illumination devices having at least one LED are described in DE 199 19 096 A1, US 2009/0034054 A1 and U.S. Pat. No. 4,852,985 B.

In practical use, an incident illumination device differs considerably from a transmitted illumination device. In an incident illumination device, the light is directed through the objective, which usually also acts as a condenser. In most cases, unlike in transmitted illumination, no additional condenser is provided.

When changing objectives, an operation frequently carried out in practice, it is necessary to adjust the illumination of the condenser or objective. To this end, in the case of transmitted illumination, the diameter of the bundle of rays in the aperture plane of the condenser must be variable by a factor of about 10 between approximately 2 mm and 20 mm. However, in the case of incident illumination, when the objective is changed, the condenser is inherently changed as well. Therefore, the diameter of the bundle of rays in the rear focal plane of the objective must be variable only by a factor of about 3 between approximately 3 mm and 10 mm.

An incident illumination device, in which a conventional incandescent lamp is replaced by an LED, is disclosed in US 2009/0016059 A1. Like conventional incandescent illumination, this illumination device has the disadvantage of being cumbersome to use when it comes to providing different illumination modes, such as bright-field, dark-field and oblique illumination. Oblique illumination is usually obtained by narrowing the aperture diaphragm and displacing it laterally from the optical axis toward the periphery. This requires the user to make many adjustments, such as aperture size, magnitude and azimuth of the offset. Such adjustments are not immediately perceptible and, therefore, can hardly be reproduced. Furthermore, when changing objectives (turret), it is necessary to adjust the settings.

### SUMMARY OF THE INVENTION

It is, therefore, desirable to devise an incident illumination device for a microscope which, in addition to conventional incident bright-field illumination, will also allow angular or oblique incident illumination to be provided in a simple and variable, yet reproducible manner.

According to a first aspect of the invention, an incident illumination device for a microscope for providing selectively oblique or straight incident illumination is provided, comprising a light source that includes at least two 2-dimensional, surface light-emitting segments and is imaged into an aperture plane of the incident illumination device, wherein at least one of the at least two light-emitting segments of the light source is designed to be activated individually and the light source is arranged such that at least one boundary between two light-emitting segments extends through an optical axis of the incident illumination device. 2-dimensional, surface emitting segments, particularly LEDs, emit light over a significant surface area in contrast to point light sources. The incident illumination device can also, optionally, be operated such as to provide straight illumination, but in any case may provide oblique illumination. Preferably, depending on the configuration of the driver that drives the light emitting segments, it is possible to switch between oblique and straight illumination. In case straight illumination is not desired, it is possible to configure the driver such that only oblique illumination is provided. In any case, the actual structural design allows selectively both options. In the alternative, if only the limited use of oblique illumination is desired, it is also possible to arrange the light emitting segments such that no boundary between the sections extends through the optical axis.

According to a second aspect of the invention, a microscope is provided, comprising: an objective; and an incident illumination device for providing selectively oblique or straight incident illumination; wherein the incident illumination device comprises a light source that includes at least two 2-dimensional, surface light-emitting segments and is imaged into an aperture plane of the incident illumination device, and at least one of the at least two light-emitting segments of the light source is designed to be activated individually and the light source is arranged such that at least one boundary between two light-emitting segments extends through an optical axis of the incident illumination device.

According to a third aspect of the invention, an incident illumination method for illuminating a sample in a microscope comprising an objective and an incident illumination device is provided, wherein the incident illumination device comprises a light source that includes at least two 2-dimensional, surface light-emitting segments and is imaged into an aperture plane of the incident illumination device, and at least one of the at least two light-emitting segments of the light source is designed to be activated individually, said method comprising activating the at least two light-emitting segments of the light source such as to provide a light-emitting surface that is asymmetrical with respect to an optical axis of the illumination beam path in order to provide oblique illumination.

According to a fourth aspect of the invention, an incident illumination method for illuminating a sample in a microscope comprising an objective and an incident illumination device is provided, wherein the incident illumination device comprises a light source that includes at least two 2-dimensional, surface light-emitting segments and is imaged into an aperture plane of the incident illumination device, and at least one of the at least two light-emitting segments of the light source is designed to be activated individually, said method comprising activating the at least two light-emitting segments of the light source such as to provide a light-emitting surface that is symmetrical with respect to an optical axis of the illumination beam path in order to provide straight illumination.

According to a fifth aspect of the invention, an incident illumination method for illuminating a sample in a microscope comprising an objective and an incident illumination device is provided, wherein the incident illumination device comprises a light source that includes at least two 2-dimensional, surface light-emitting segments and is imaged into an aperture plane of the incident illumination device, and at least one of the at least two light-emitting segments of the light source is designed to be activated individually, said method comprising activating a first number and a second number of light-emitting segments of the light source in a time-staggered manner and such that the overall illumination intensity remains substantially constant. In case only the limited use of oblique illumination is desired, it is possible that the light emitting segments in the device operating under said method are arranged such that no boundary between the sections extends through the optical axis. However, it is preferably that an optical axis runs through at least one boundary between at least 2 light emitting segments so that depending on driving these segments either oblique or straight incident illumination can be accomplished.

### DETAILED DESCRIPTION OF THE INVENTION

The present invention teaches that in an incident illuminator, different illumination modes can be provided in a simple and reproducible manner when using a light source that is divided into a number of 2-dimensional, surface light-emitting segments, at least one light-emitting segment being controllable or operable independently of the others. The light source is imaged into an illuminating aperture plane of the incident illumination device. Surface-emitting LEDs are particularly suitable for use as the light-emitting segments. A light-emitting segment provides a light-emitting surface and is therefore different from the LEDs used in the prior art, where a light-emitting spot is located within a transparent housing. Accordingly, in conventional LEDs, adjacent light-emitting spots are spaced apart by relatively large distances.

The present invention does not take the approach of placing a plurality of LEDs in the aperture plane so as to reduce the number of optical elements, allowing elimination of a collector lens or an aperture diaphragm, for example. Rather, it has been discovered that placing a suitable light source behind the aperture plane and imaging said light source into the aperture plane offers numerous advantages. Because the light source is imaged into an aperture plane, it is possible to choose a light source of relatively small area which includes only a small number of light-emitting segments and is suitably magnified as it is imaged into the aperture plane, and which provides a high filling factor. Such a design is small, requires a minimum of wiring, and emits relatively little heat. In addition, this design offers the advantage of being able to provide an aperture diaphragm. This is not possible in prior art approaches, where an LED array is disposed in the aperture plane. By using 2-dimensional, surface light-emitting segments in place of conventional, individual LEDs, a high filling factor can be achieved. Because of the extent of the light-emitting segments, only a low luminance level is needed, and a uniform illumination of the pupil is obtained. When stopping down the aperture, for example during bright-field illumination, there are no sudden changes or steps in the perceived brightness.

Conveniently, the surface area and/or extent of a light-emitting segment is larger, in particular at least four, five, eight or ten times larger, than the spacing area; i.e., than the space between light-emitting segments. Advantageously, a filling factor of at least 75%, preferably of at least 80%, is provided. In the preferred arrangement, in which the spaces between the light-emitting segments are narrow, only a small portion of the illuminating aperture plane is dark. In contrast, in the case of a light source having a plurality of spaced-apart light-emitting spots (LEDs), there may be annular zones of large area (particularly in the outer aperture zone) that are not illuminated.

In order to provide incident bright-field illumination, the light-emitting segments are activated to provide a light-emitting surface that is symmetrical to the optical axis of the illumination beam path. On the other hand, in order to provide oblique illumination, one or more light-emitting segments are activated to provide a light-emitting surface that is asymmetrical with respect to the optical axis of the illumination beam path. By activating individual light-emitting segments, which are located in defined positions due to design requirements, oblique illumination can be provided in a reproducible manner. When activating the light-emitting segments in a time-staggered manner, such as one after the other in a circular pattern, the oblique illumination will move around the sample. This makes it possible to provide oblique illumination from all sides, so that contrasts will become apparent in all directions. Switching between different illumination modes may occur in a particularly convenient manner for the user if the overall illumination intensity remains substantially constant during the process. In the case of a light source having four light-emitting segments, for example, the illumination may be switched from bright-field illumination at 4×25% to oblique illumination at 1×100% or 2×50% and vice versa. This eliminates the need for the user to readjust brightness after a switching operation. In particular, it is possible to prevent dazzling effects from occurring when switching from oblique illumination to bright-field illumination.

When a variable aperture diaphragm is disposed in the illuminating aperture plane, it is advantageously possible to adjust the contrast, depth of field and resolution of an imaging system, such as a microscope, which may be provided downstream of the illumination device, since the illuminating aperture plane is conjugate to the pupil of the objective, which is in turn located in the rear focal plane of the objective. Closing down the aperture diaphragm increases contrast and depth of field and reduces resolution.

Preferably, the light-emitting segments are shaped as sectors of a circle or as polygons, in particular as triangles or rectangles. Equiangular and/or equilateral polygons are particularly suited to achieve a high filling factor. Suitable SMD-type LED modules including a number of rectangular light-emitting segments are marketed, for example, by the Osram Optosemiconductors Company under the designation of “OSTAR”.

Preferably, at least one division or boundary between light-emitting segments extends through the optical axis of the incident illumination device, so that when the light-emitting segments are activated individually (depending on the design, one half, one third, one quarter, one sector, one quadrant, etc.), sufficient oblique illumination can be provided, and when all light-emitting segments are activated together, sufficient bright-field illumination can be provided. In this configuration, no light-emitting element is provided on the optical axis. This is of particular advantage for oblique illumination because a central light-emitting element would have to be turned off to enable oblique illumination. As a result, the size of the permissible aperture diameter would have a lower limit because it would always have to be larger than the turned-off central element.

Advantageously, all boundaries between each two light-emitting segments extend through the optical axis of the incident illumination device. This enables bright-field illumination and oblique illumination to be provided in a particularly simple manner because, by simple control, the centroid (weighted center) of the bright-field illumination can be placed on the optical axis, and the centroid of the oblique illumination can be placed offset from the optical axis. Depending on the embodiment, the light-emitting segments can be activated individually or in groups. For example, it may be possible to jointly activate light-emitting segments which are located opposite each other relative to the optical illumination axis. Alternatively, or in addition, it may be possible to jointly activate light-emitting segments which are adjacent to each other. The number of jointly activatable light-emitting segments can, in each case, be freely selected.

Advantageously, the light source includes four quadrants as the light-emitting segments. Using such a configuration, a light source capable of providing both straight bright-field illumination and angular or oblique incident illumination can be provided in a simple manner. Because of the small number of light-emitting segments, little effort is required for wiring and interconnection. The light source may be small in size, which reduces space requirements and heat emission. By projecting a suitably magnified image of the light source into the illuminating aperture plane, it is nevertheless possible to achieve large-area illumination.

The light-emitting segments may be designed as a white light source, in particular as a white light LED, or as an RGB light source, in particular as an RGB LED, respectively. In the second case, it is possible, for example, to adjust the color temperature of the illumination by driving the individual red, green and blue elements separately. If the brightness of the light-emitting segments is controllable, the illumination intensity can thereby be adjusted to match the particular requirements.

In a practical embodiment, the light-emitting segments are arranged on a common carrier. Therefore, the light-emitting segments can be easily connected, which keeps the wiring effort low. More particularly, individual LEDs may be arranged on a common chip and/or in a common housing. Using this technology, the distance between the individual light-emitting segments can be minimized, and the light sources can be positioned relative to each other with sufficient accuracy. A suitable module of the above-mentioned “OSTAR” series, which has four quadrants with an area of approximately 1×1 mm² each, and a segment spacing of approximately 0.1 mm, carries the designation LE UW S2W.

It is advantageous if the light source is rotatably mounted around the optical axis of the incident illumination device. In this manner, oblique illumination can be achieved at any angle.

In a practical embodiment of a microscope according to the present invention, the illuminating aperture plane of the incident illumination device is conjugate to the rear focal plane of the objective. This makes it possible to achieve, in particular, Köhler illumination.

Further advantages and embodiments of the present invention will become apparent from the following description and the accompanying drawings.

It will be understood that the aforementioned features and those described below can be used not only in the specified combinations, but also in other combinations or alone without departing from the scope of the present invention.

The subject matter of the present invention is depicted schematically in the drawing using an exemplary embodiment, and will be described below in detail with reference to the drawings.

### BRIEF DESCRIPTION OF THE DRAWINGS

FIG. 1 is a schematic side view of a preferred embodiment of a microscope of the present invention having an incident illumination device;

FIG. 2 is a schematic side view of an embodiment of an incident illumination device according to the present invention;

FIG. 3 is a view of a first light source suitable for use in an incident illumination device according to the present invention;

FIG. 4 is a view of a second light source suitable for use in an incident illumination device according to the present invention;

FIG. 5 is a view of a third light source suitable for use in an incident illumination device according to the present invention;

FIG. 6 is a view of a fourth light source suitable for use in an incident illumination device according to the present invention.

### DETAILED DESCRIPTION OF THE DRAWINGS

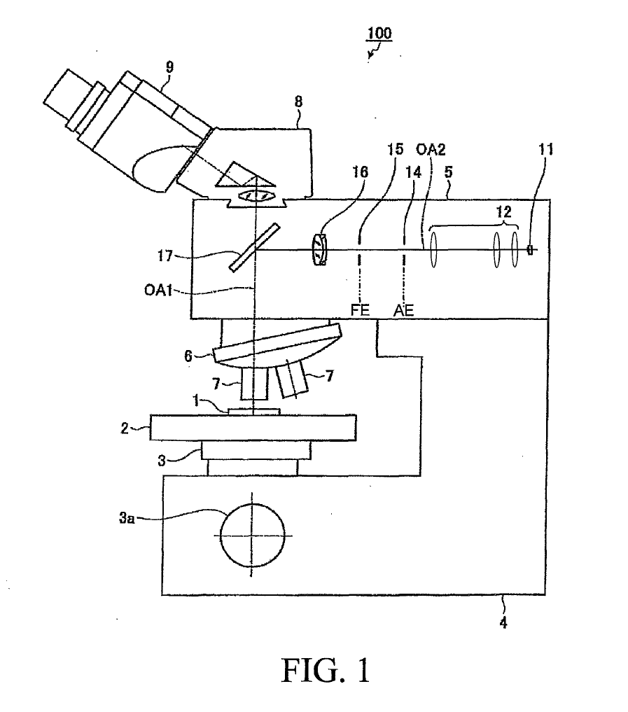

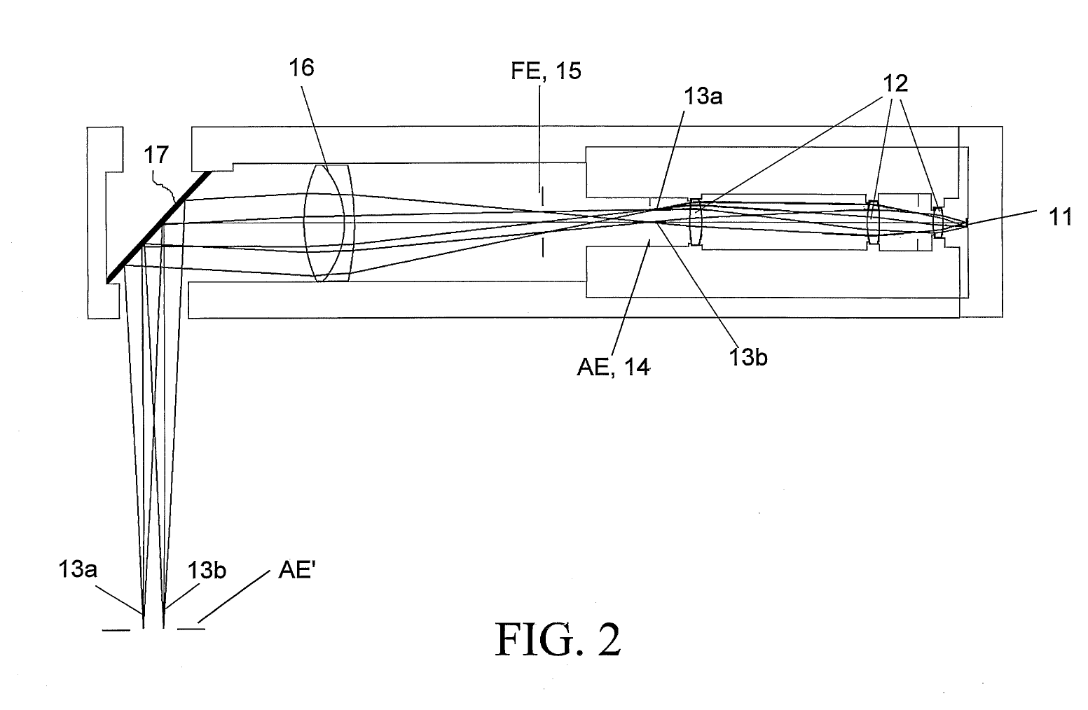

FIGS. 1 and 2 are described collectively below, with like elements being given the same reference numerals.

Referring to FIG. 1, a microscope for examining a sample 1 is shown schematically in a cross-sectional view and denoted as a whole by 100. The microscope has a microscope body 4 to which a microscope stage 2 is mounted by a support member 3. Sample 1 is placed on microscope stage 2 and can be moved vertically using an adjustment means in the form of a rotary wheel 3a. Individual objectives 7 are provided on an objective turret 6. An incident illumination device 5 is provided to illuminate sample 1. The illuminating light reflected from sample 1 travels along the observation beam path through a tube 8 to eyepiece 9. The optical axis of the observation beam path is denoted by OA1.

Incident illumination device 5 includes a light source 11, which is imaged into an aperture plane AE by means of a first lens system 12. An aperture diaphragm 14 is disposed in aperture plane AE. Aperture diaphragm 14 may be in the form of a variable iris diaphragm, a diaphragm slide, or the like. A second lens system 16 is provided to image aperture plane AE into rear focal plane AE′ of objective 7. The corresponding paths of ray bundles 13a and 13b originating from light source 11 are illustrated in FIG. 2. Further, a field diaphragm 15 disposed in a field plane FE is imaged onto sample 1.

The optical axis of incident illumination device 5 is denoted by OA2. At a beam splitter 17, optical axis OA2 meets optical axis OA1 of the imaging beam path.

In the Figure shown, lens system 12 includes three lenses, and lens system 16 includes two lenses. However, it will be understood that lens systems 12 and 16 may each include any number of lenses.

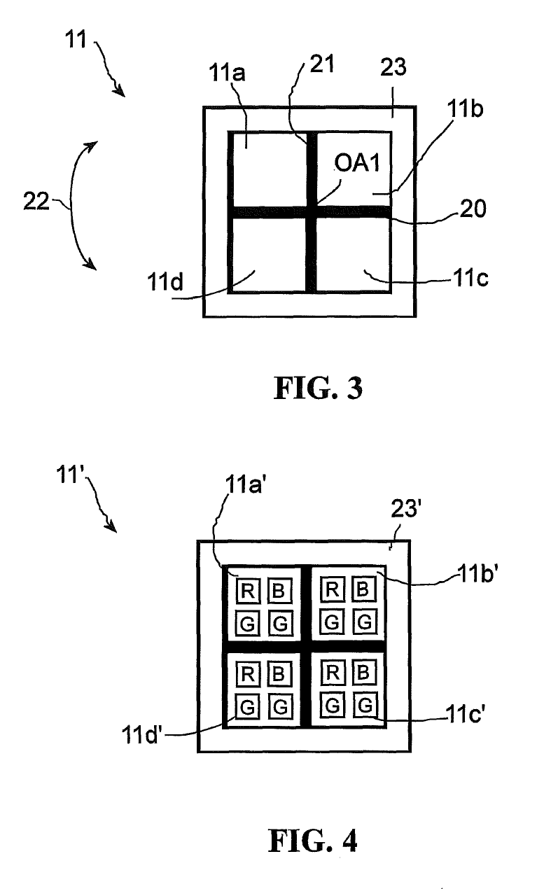

Referring to FIG. 3, a first embodiment of a light source 11 suitable for the present invention is shown in a plan view. Light source 11 has four light-emitting segments in the form of quadrants 11a, 11b, 11c and 11d, which can be individually activated and controlled in brightness. Adjacent quadrants are separated by boundaries 20 and 21, which each extend through and intersect at optical axis OA2 of the illumination device. Quadrants 11a, 11b, 11c and 11d are arranged on a common carrier 23. Quadrants 11a through 11d are designed as white light LEDs or include such LEDs.

In order to provide incident bright-field illumination, advantageously, all quadrants 11a through 11d are activated, thereby providing a substantially homogeneously radiating light-emitting surface. In order to provide oblique incident illumination, advantageously, only one of the quadrants 11a through 11d is activated. However, it will be understood that it is also possible to activate more than one quadrant to provide oblique illumination.

According to the above-described preferred embodiment of the present invention, all four quadrants 11a through 11d can be activated individually. This makes it possible to provide different illumination patterns, it being possible to activate, for example, adjacent quadrants 11a, 11b; 11b, 11c; 11c, 11d; 11d, 11a, or diagonally opposite quadrants 11b, 11d; 11a, 11c. Optionally, light source 11 may be rotatably mounted around optical axis OA2, which is indicated by arrow 22.

FIG. 4 shows a further embodiment of a light source 11′ suitable for the present invention. Light source 11′ similarly has four quadrants 11a′ 11b′ 11c′ 11d′, each of quadrants 11a′ through 11d′ having a number of red, green and blue LEDs denoted by R, B and G, respectively. Preferably, the color LEDs forming a quadrant are also adjustable, allowing the color temperature of the illumination to be varied. Quadrants 11a′ through 11d′ in turn are arranged on a common carrier 23′.

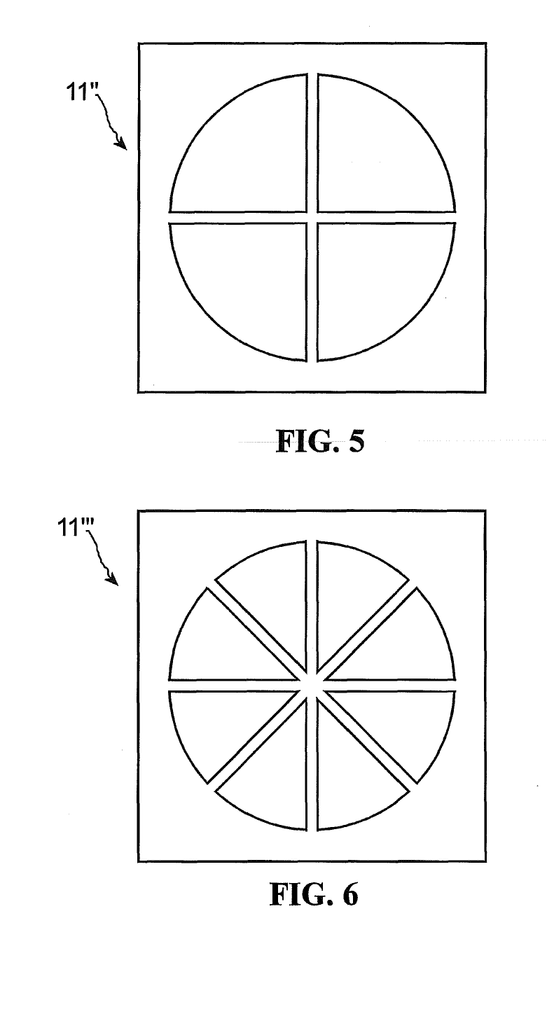

FIGS. 5 and 6 show two circular light sources 11″ and 11′″, which each have a number of light-emitting segments shaped as segments of a circle. Light source 11″ has four light-emitting segments, and light source 11′″ has eight light-emitting segments. For the sake of clarity, the individual light-emitting segments are not given reference numerals.

The light sources shown in FIGS. 3 through 6 are particularly suited for illumination according to a preferred embodiment of the present invention, whereby a first number and a second number of light-emitting segments of the light source are activated in a time-staggered manner and such that the overall illumination intensity remains substantially constant. The number of light-emitting segments may include one or more such segments. For example, referring to FIGS. 3 through 5, it would be possible to drive one light-emitting segment at 100%, two light-emitting segments at 50% each, three light-emitting segments at 33.33% each, or all four light-emitting segments at 25% intensity each. Activation may take place in any sequence.

It will be understood that the embodiment shown in the Figures herein is merely illustrative of the present invention, and that the present invention may be embodied in any other form without departing from its scope.

What is claimed is:

1. An incident illumination device for a microscope for providing selectively oblique or straight incident illumination, comprising a light source that includes at least two 2-dimensional, surface light-emitting segments and is imaged into an aperture plane of the incident illumination device, wherein at least one of the at least two light-emitting segments of the light source is designed to be activated individually and the light source is arranged such that at least one boundary between two light-emitting segments extends through an optical axis of the incident illumination device.

2. The incident illumination device as recited in claim 1, wherein at least one light-emitting segment of the light source is shaped as at least one of a polygon and a sector of a circle.

3. The incident illumination device as recited in claim 1, wherein the light source is arranged such that all boundaries between each two adjacent light-emitting segments extend through the optical axis of the incident illumination device.

4. The incident illumination device as recited in claim 1, wherein the light source includes four quadrants as the light-emitting segments.

5. The incident illumination device as recited in claim 1, wherein the light-emitting segments can be individually controlled in brightness.

6. The incident illumination device as recited in claim 1, wherein the light-emitting segments are arranged on at least one of a common carrier and in a common housing.

7. The incident illumination device as recited in claim 1, wherein at least one light-emitting segment is designed as a white light source.

8. The incident illumination device as recited in claim 1, wherein at least one light-emitting segment is designed as an RGB light source.

9. The incident illumination device as recited in claim 1, wherein the light source is rotatably mounted around an optical axis of the incident illumination device.

10. A microscope comprising:
an objective; and
an incident illumination device for providing selectively oblique or straight incident illumination; wherein
the incident illumination device comprises a light source that includes at least two 2-dimensional, surface light-emitting segments and is imaged into an aperture plane of the incident illumination device, and at least one of the at least two light-emitting segments of the light source is designed to be activated individually and the light source is arranged such that at least one boundary between two light-emitting segments extends through an optical axis of the incident illumination device.

11. The microscope as recited in claim 10, wherein the illuminating aperture plane of the incident illumination device is conjugate to the rear focal plane of the objective.

12. The microscope as recited in claim 10, wherein at least one light-emitting segment of the light source is shaped as at least one of a polygon and a sector of a circle.

13. The microscope as recited in claim 10, wherein the light source is arranged such that all boundaries between each two adjacent light-emitting segments extend through the optical axis of the microscope.

14. The microscope as recited in claim 10, wherein the light source includes four quadrants as the light-emitting segments.

15. The microscope as recited in claim 10, wherein the light-emitting segments can be individually controlled in brightness.

16. The microscope as recited in claim 10, wherein the light-emitting segments are arranged on at least one of a common carrier and in a common housing.

17. The microscope as recited in claim 10, wherein at least one light-emitting segment is designed as a white light source.

18. The microscope as recited in claim 10, wherein at least one light-emitting segment is designed as an RGB light source.

19. The microscope as recited in claim 10, wherein the light source is rotatably mounted around an optical axis of the incident illumination device.

20. An incident illumination method for illuminating a sample in a microscope comprising an objective and an incident illumination device, wherein the incident illumination device comprises a light source that includes at least two 2-dimensional, surface light-emitting segments and is imaged into an aperture plane of the incident illumination device, and at least one of the at least two light-emitting segments of the light source is designed to be activated individually, said method comprising activating the at least two light-emitting segments of the light source such as to provide a light-emitting surface that is asymmetrical with respect to an optical axis of the illumination beam path in order to provide oblique illumination.

21. The incident illumination method as recited in claim 20, further comprising activating of the light-emitting segments of the light source in a time-staggered manner.

22. An incident illumination method for illuminating a sample in a microscope comprising an objective and an incident illumination device, wherein the incident illumination device comprises a light source that includes at least two 2-dimensional, surface light-emitting segments and is imaged into an aperture plane of the incident illumination device, and at least one of the at least two light-emitting segments of the light source is designed to be activated individually, said method comprising activating the at least two light-emitting segments of the light source such as to provide a light-emitting surface that is symmetrical with respect to an optical axis of the illumination beam path in order to provide straight illumination.

23. An incident illumination method for illuminating a sample in a microscope comprising an objective and an incident illumination device, wherein the incident illumination device comprises a light source that includes at least two 2-dimensional, surface light-emitting segments and is imaged into an aperture plane of the incident illumination device, and at least one of the at least two light-emitting segments of the light source is designed to be activated individually, said method comprising activating a first number and a second number of light-emitting segments of the light source in a time-staggered manner and such that the overall illumination intensity remains substantially constant.
